(19) United States
(12) Patent Application Publication
(10) Pub. No.: US 2024/0152790 A1
(43) Pub. Date: May 9, 2024

(54) ASSISTING USERS IN CREATING QUANTUM CIRCUITS BY DISPLAYING FILTERS USED TO PROVIDE RELEVANT INFORMATION REGARDING GROUPED QUANTUM LOGIC GATES

(71) Applicant: International Business Machines Corporation, Amonk, NY (US)

(72) Inventors: Joel Russell Huffman, Austin, TX (US); Kristen Zelenka Lee, Austin, TX (US); Frank Harkins, Winchester (GB)

(21) Appl. No.: 17/982,391

(22) Filed: Nov. 7, 2022

(51) Int. Cl. G06N 10/20

(52) U.S. Cl. CPC G06N 10/20

(57) ABSTRACT

A method, system and computer program product for assisting users in creating quantum circuits. Quantum logic gates of a quantum circuit (being designed by a user) that are to be grouped together are identified. Upon identifying such quantum logic gates, those quantum logic gates are grouped together into a grouped set of quantum logic gates. Upon forming a grouped set of quantum logic gates, filters are displayed in connection with the quantum circuit being designed by the user, where each of these filters is configured to display particular information (e.g., which gates form the grouped set of quantum logic gates, illustrate how the grouped set of quantum logic gates is transpiled to a hardware system) regarding the grouped set of quantum logic gates. For example, such filters may be visually displayed on the top of the quantum circuit being built by the user in a graphical user interface.

### TECHNICAL FIELD

The present disclosure relates generally to graphical quantum programming tools, and more particularly to assisting users in creating quantum circuits by visually displaying filters, which are used to provide relevant information regarding grouped quantum logic gates.

### BACKGROUND

Graphical quantum programming tools are software tools used for building and simulating quantum circuits for use in quantum computers, which perform quantum computations. A quantum circuit is a model for quantum computation, similar to classical circuits, in which a computation is a sequence of quantum logic gates, measurements, initializations of qubits to known values, and possibly other actions. The minimum set of actions that a quantum circuit needs to be able to perform on the qubits to enable quantum computation is known as DiVincenzo's criteria.

### SUMMARY

In one embodiment of the present disclosure, a method for assisting users in creating quantum circuits comprises identifying quantum logic gates of a quantum circuit to be grouped together. The method further comprises grouping the identified quantum logic gates into a grouped set of quantum logic gates. The method additionally comprise displaying a plurality of filters in connection with the quantum circuit, where each of the plurality of filters is configured to display particular information regarding the grouped set of quantum logic gates.

Other forms of the embodiment of the method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the classical computer for assisting users in creating quantum circuits by visually displaying filters on a graphical user interface in connection with designing a quantum circuit, where the filters are used to provide relevant information regarding grouped quantum logic gates, in accordance with an embodiment of the present disclosure;

FIG. 3 illustrates a graphical user interface which displays a quantum circuit being built by a user as well as filters which are displayed in connection with the quantum circuit in accordance with an embodiment of the present disclosure;

FIG. 4 illustrates a filter which indicates which quantum logic gates form the grouped set of quantum logic gates in accordance with an embodiment of the present disclosure;

FIG. 5 illustrates a filter which indicates how the grouped set of quantum logic gates is transpiled to a hardware system in accordance with an embodiment of the present disclosure;

FIG. 6 illustrates a filter which provides information regarding the quantum logic gate(s) of the grouped set of quantum logic gates not being able to run on a quantum computer in accordance with an embodiment of the present disclosure;

FIG. 7 illustrates a filter which provides fidelity information regarding the grouped set of quantum logic gates in accordance with an embodiment of the present disclosure;

FIG. 8 illustrates a filter which indicates interchangeable gates within the grouped set of quantum logic gates in accordance with an embodiment of the present disclosure;

FIG. 9 illustrates a filter which indicates the performance of a quantum logic gate within the grouped set of quantum logic gates when it is transpiled to the quantum circuit in accordance with an embodiment of the present disclosure;

FIG. 10 illustrates an embodiment of the present disclosure of the hardware configuration of the classical computer which is representative of a hardware environment for practicing the present disclosure; and

FIG. 11 is a flowchart of a method for assisting users in creating quantum circuits by visually displaying filters, which are used to provide relevant information regarding grouped quantum logic gates, in accordance with an embodiment of the present disclosure.

### DETAILED DESCRIPTION

As stated in the Background section, graphical quantum programming tools are software tools used for building and simulating quantum circuits for use in quantum computers, which perform quantum computations. A quantum circuit is a model for quantum computation, similar to classical circuits, in which a computation is a sequence of quantum logic gates, measurements, initializations of qubits to known values, and possibly other actions. The minimum set of actions that a quantum circuit needs to be able to perform on the qubits to enable quantum computation is known as DiVincenzo's criteria.

In quantum computing, a qubit or quantum bit is a basic unit of quantum information—the quantum version of the classic binary bit physically realized with a two-state device. A qubit is a two-state (or two-level) quantum-mechanical system, one of the simplest quantum systems displaying the peculiarity of quantum mechanics. Examples include the spin of the electron in which the two levels can be taken as spin up and spin down; or the polarization of a single photon in which the two states can be taken to be the vertical polarization and the horizontal polarization. In a classical system, a bit would have to be in one state or the other. However, quantum mechanics allow the qubit to be in a coherent superposition of both states simultaneously, a property that is fundamental to quantum mechanics and quantum computing.

Quantum circuits are written such that the horizontal axis is time, starting at the left hand side and ending at the right hand side. Horizontal lines are qubits and doubled lines represent classical bits. The items that are connected by these lines are operations performed on the qubits, such as measurements or gates. These lines define the sequence of events and are usually not physical cables.

As discussed above, graphical quantum programming tools (e.g., IBM® Quantum Composer, Quirk) are software tools used for building and simulating such quantum circuits. Typically, such tools allow the user (e.g., developer, researcher) to build the quantum circuit via drag and drop operations, which are then run on quantum hardware or simulators. For example, a quantum circuit may be built by dragging and dropping quantum logic gates.

However, such graphical quantum programming tools fail to provide a deeper understanding and robust circuit development experience. For example, such tools fail to provide relevant information associated with particular circuit elements to assist the user in making better decisions as well as speeding up the design process in building the quantum circuit.

The embodiments of the present disclosure expand the capabilities in quantum circuit creation by grouping quantum logic gates and visually displaying “filters” providing relevant information regarding the grouped quantum logic gates so that the users (e.g., developers, researchers) can better understand the capabilities and underlying mechanics of a given quantum circuit as discussed in further detail below.

In some embodiments of the present disclosure, the present disclosure comprises a method, system and computer program product for assisting users in creating quantum circuits. In one embodiment of the present disclosure, quantum logic gates of a quantum circuit (being designed by a user) that are to be grouped together are identified. Upon identifying such quantum logic gates, those quantum logic gates are grouped together into a grouped set of quantum logic gates. In one embodiment, such quantum logic gates are identified to be grouped together based on one or more of the following characteristics: color, type, barrier, customization, etc. Upon forming a grouped set of quantum logic gates, filters are displayed in connection with the quantum circuit being designed by the user, where each of these filters is configured to display particular information regarding the grouped set of quantum logic gates. A “filter,” as used herein, refers to a graphical display of information regarding the grouped quantum logic gates that may be displayed at or near the quantum circuit being built by the user (e.g., developer, researcher). For example, such filters may be visually displayed on the top of the quantum circuit being built by the user in a graphical user interface. In one embodiment, such filters display the following information: (1) illustrate which gates form the grouped set of quantum logic gates; (2) illustrate how the grouped set of quantum logic gates is transpiled to a hardware system; (3) provide information regarding the quantum logic gate(s) of the grouped set of quantum logic gates not being able to run on a quantum computer; (4) provide fidelity information regarding the grouped set of quantum logic gates; (5) illustrate interchangeable gates within the grouped set of quantum logic gates; and (6) illustrate performance of a quantum logic gate within the grouped set of quantum logic gates when it is transpiled to the quantum circuit. In this manner, users are provided a deeper understanding and a robust circuit development experience by providing relevant information regarding a grouped set of quantum logic gates so that the user can better understand the capabilities and underlying mechanics of the quantum circuit.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill the relevant art.

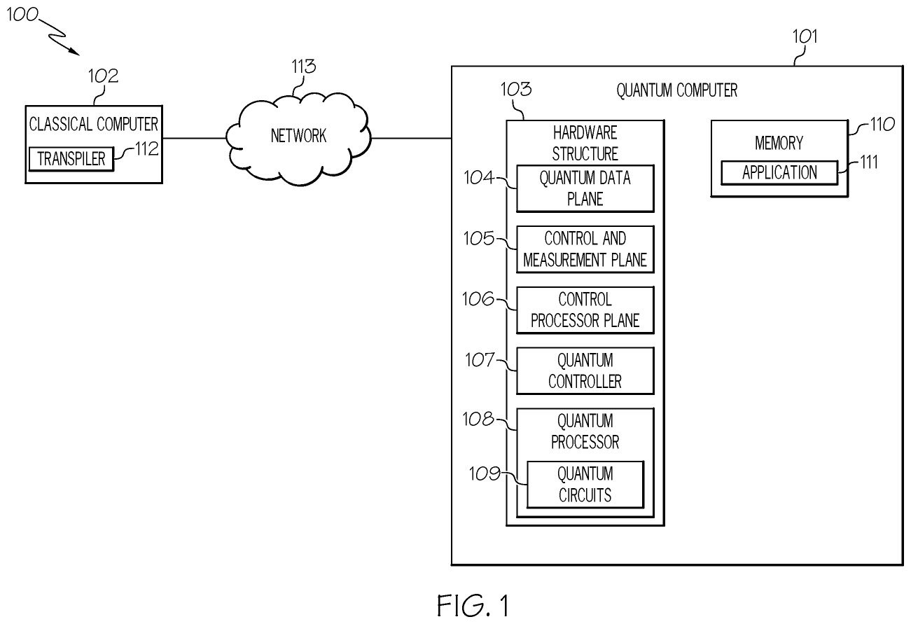

Referring now to the Figures in detail, FIG. 1 illustrates an embodiment of the present disclosure of a communication system 100 for practicing the principles of the present disclosure. Communication system 100 includes a quantum computer 101 configured to perform quantum computations, such as the types of computations that harness the collective properties of quantum states, such as superposition, interference and entanglement, as well as a classical computer 102 in which information is stored in bits that are represented logically by either a 0 (off) or a 1 (on). Examples of classical computer 102 include, but not limited to, a portable computing unit, a Personal Digital Assistant (PDA), a laptop computer, a mobile device, a tablet personal computer, a smartphone, a mobile phone, a navigation device, a gaming unit, a desktop computer system, a workstation, and the like configured with the capability of connecting to network 113 (discussed below).

In one embodiment, classical computer 102 is used to setup the state of quantum bits in quantum computer 101 and then quantum computer 101 starts the quantum process. Furthermore, in one embodiment, classical computer 102 is configured to assist users (e.g., designers, researchers) in creating quantum circuits by visually displaying filters on a graphical user interface in connection with designing a quantum circuit, where such filters are used to provide relevant information regarding grouped quantum logic gates as discussed further below.

In one embodiment, a hardware structure 103 of quantum computer 101 includes a quantum data plane 104, a control and measurement plane 105, a control processor plane 106, a quantum controller 107 and a quantum processor 108.

Quantum data plane 104 includes the physical qubits or quantum bits (basic unit of quantum information in which a qubit is a two-state (or two-level) quantum-mechanical system) and the structures needed to hold them in place. In one embodiment, quantum data plane 104 contains any support circuitry needed to measure the qubits' state and perform gate operations on the physical qubits for a gate-based system or control the Hamiltonian for an analog computer. In one embodiment, control signals routed to the selected qubit(s) set a state of the Hamiltonian. For gate-based systems, since some qubit operations require two qubits, quantum data plane 104 provides a programmable “wiring” network that enables two or more qubits to interact.

Control and measurement plane 105 converts the digital signals of quantum controller 107, which indicates what quantum operations are to be performed, to the analog control signals needed to perform the operations on the qubits in quantum data plane 104. In one embodiment, control and measurement plane 105 converts the analog output of the measurements of qubits in quantum data plane 104 to classical binary data that quantum controller 107 can handle.

Control processor plane 106 identifies and triggers the sequence of quantum gate operations and measurements (which are subsequently carried out by control and measurement plane 105 on quantum data plane 104). These sequences execute the program, provided by quantum processor 108, for implementing a quantum algorithm.

In one embodiment, control processor plane 106 runs the quantum error correction algorithm (if quantum computer 101 is error corrected).

In one embodiment, quantum processor 108 uses qubits to perform computational tasks. In the particular realms where quantum mechanics operate, particles of matter can exist in multiple states, such as an “on” state, an “off” state and both “on” and “off” states simultaneously. Quantum processor 108 harnesses these quantum states of matter to output signals that are usable in data computing.

In one embodiment, quantum processor 108 performs algorithms which conventional processors are incapable of performing efficiently.

In one embodiment, quantum processor 108 includes one or more quantum circuits 109. Quantum circuits 109 may collectively or individually be referred to as quantum circuits 109 or quantum circuit 109, respectively. A “quantum circuit 109,” as used herein, refers to a model for quantum computation in which a computation is a sequence of quantum logic gates, measurements, initializations of qubits to known values and possibly other actions. A “quantum logic gate,” as used herein, is a reversible unitary transformation on at least one qubit. Quantum logic gates, in contrast to classical logic gate, are all reversible. Examples of quantum logic gates include RX (performs e^{iθX}, which corresponds to a rotation of the qubit state around the X-axis by the given angle theta θ on the Bloch sphere), RY (performs e^{iθY}, which corresponds to a rotation of the qubit state around the Y-axis by the given angle theta θ on the Bloch sphere), RXX (performs the operation e^{(-iθ/2X⊕X)} on the input qubit), RZZ (takes in one input, an angle theta θ expressed in radians, and it acts on two qubits), etc. In one embodiment, quantum circuits 109 are written such that the horizontal axis is time, starting at the left hand side and ending at the right hand side.

Furthermore, in one embodiment, quantum circuit 109 corresponds to a command structure provided to control processor plane 106 on how to operate control and measurement plane 105 to run the algorithm on quantum data plane 104/quantum processor 108.

Furthermore, quantum computer 101 include memory 110, which may correspond to quantum memory. In one embodiment, memory 110 is a set of quantum bits that store quantum states for later retrieval. The state stored in quantum memory 110 can retain quantum superposition.

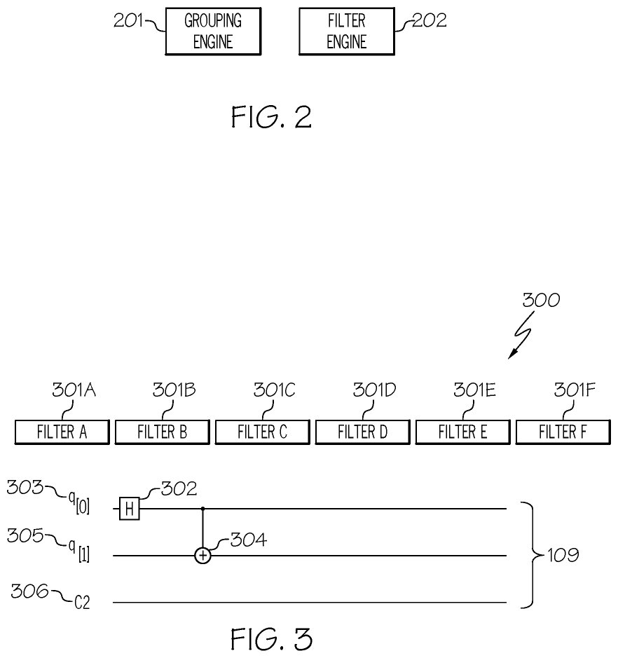

In one embodiment, memory 110 stores an application 111 that may be configured to implement one or more of the methods described herein in accordance with one or more embodiments. For example, application 111 may implement a program for assisting users (e.g., designers, researchers) in creating quantum circuits by visually displaying filters on a graphical user interface in connection with designing a quantum circuit, where such filters are used to provide relevant information regarding grouped quantum logic gates, as discussed further below in connection with FIGS. 2-11. Examples of memory 110 include light quantum memory, solid quantum memory, gradient echo memory, electromagnetically induced transparency, etc.

Furthermore, in one embodiment, classical computer 102 includes a “transpiler 112,” which as used herein, is configured to rewrite an abstract quantum circuit 109 into a functionally equivalent one that matches the constraints and characteristics of a specific target quantum device. In one embodiment, transpiler 112 (e.g., qiskit.transpiler, where Qiskit is an open-source software development kit for working with quantum computers at the level of circuits, pulses and algorithms) converts the trained machine learning model upon execution on quantum hardware 103 to its elementary instructions and maps it to physical qubits.

In one embodiment, quantum machine learning models are based on variational quantum circuits 109. Such models consist of data encoding, processing parameterized with trainable parameters and measurement/post-processing.

In one embodiment, the number of qubits (basic unit of quantum information in which a qubit is a two-state (or two-level) quantum-mechanical system) is determined by the number of features in the data. This processing stage may include multiple layers of parameterized gates. As a result, in one embodiment, the number of trainable parameters is (number of features)*(number of layers).

Furthermore, as shown in FIG. 1, classical computer 102, which is used to setup the state of quantum bits in quantum computer 101, may be connected to quantum computer 101 via a network 113.

Network 113 may be, for example, a quantum network, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, a cellular network and various combinations thereof, etc. Other networks, whose descriptions are omitted here for brevity, may also be used in conjunction with system 100 of FIG. 1 without departing from the scope of the present disclosure.

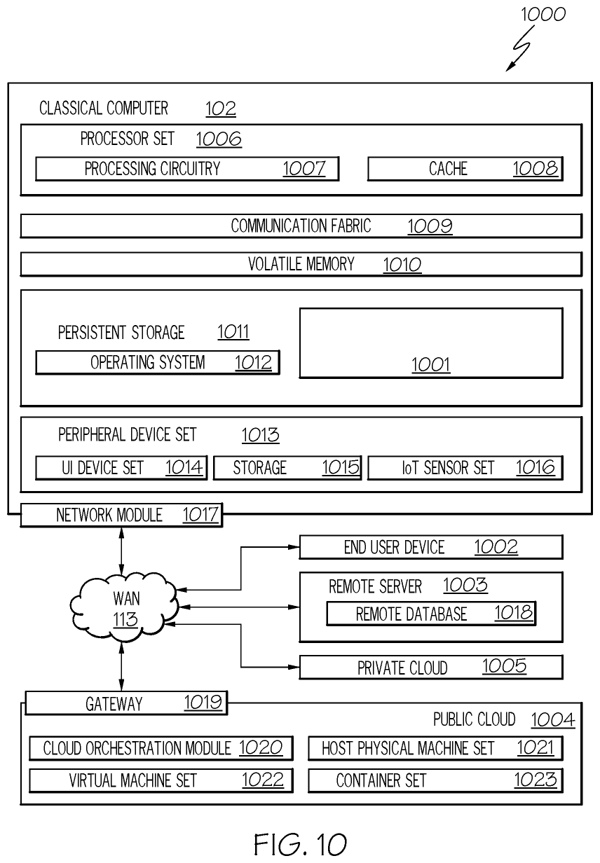

Furthermore, classical computer 102 is configured to assist users (e.g., designers, researchers) in creating quantum circuits by visually displaying filters on a graphical user interface in connection with designing a quantum circuit, where the filters are used to provide relevant information regarding grouped quantum logic gates as discussed further below in connection with FIGS. 2-11. A description of the software components of classical computer 102 is provided below in connection with FIG. 2 and a description of the hardware configuration of classical computer 102 is provided further below in connection with FIG. 10.

System 100 is not to be limited in scope to any one particular network architecture. System 100 may include any number of quantum computers 101, classical computers 102 and networks 113.

A discussion regarding the software components used by classical computer 102 for assisting users (e.g., designers, researchers) in creating quantum circuits by visually displaying filters on a graphical user interface in connection with designing a quantum circuit (e.g., quantum circuit 109), where the filters are used to provide relevant information regarding grouped quantum logic gates, is provided below in connection with FIG. 2.

FIG. 2 is a diagram of the software components of classical system 102 (FIG. 1) for assisting users (e.g., designers, researchers) in creating quantum circuits by visually displaying filters on a graphical user interface in connection with designing a quantum circuit, where the filters are used to provide relevant information regarding grouped quantum logic gates, in accordance with an embodiment of the present disclosure.

Referring to FIG. 2, in conjunction with FIG. 1, classical computer 102 includes a grouping engine 201 configured to identify quantum logic gates of quantum circuit 109 being designed by a user (e.g., designer, researcher) to be grouped together. Upon identifying such quantum logic gates, such quantum logic gates are grouped together into a grouped set of quantum logic gates by grouping engine 201.

In one embodiment, the user (e.g., designer, researcher) builds quantum circuit 109 by selecting quantum logic gates, such as a Hadamard gate or a CNOT gate, using a graphical quantum programming tool (e.g., IBM® Quantum Composer). Such quantum logic gates manipulate qubits and are the building blocks of quantum circuits 109. In one embodiment, such quantum logic gates are used to construct quantum circuit 109 via a drag and drop operation, such as by selecting a quantum logic gate (e.g., Hadamard gate) and then dragging the selected quantum logic gate onto the qubit wire. In one embodiment, grouping engine 201 is configured to group such quantum logic gates based on one or more of the following characteristics: color, type, barrier, customization, etc. Using these characteristics, grouping engine 201 identifies those quantum logic gates that should be grouped together.

For example, such quantum logic gates may be color-coded by the graphical quantum programming tool based on their functionality. For instance, CNOT and SWAP quantum logic gates may be color-coded the same color since a SWAP quantum logic gate can be obtained from three CNOT gates. In another example, the RX, RY, RXX and RZZ quantum logic gates may be color-coded the same color since such gates are rotation gates. In one embodiment, grouping engine 201 groups such quantum logic gates selected by the user to build a quantum circuit (e.g., quantum circuit 109) based on the color assigned to such gates as indicated by the graphical quantum programming tool. For example, those selected quantum logic gates that are assigned the same color may be grouped together by grouping engine 201 to form a grouped set of quantum logic gates.

In another example, grouping engine 201 may group such quantum logic gates that were selected to build the quantum circuit (e.g., quantum circuit 109) based on type. For example, rotation gates, phase shift gates, controlled gates, Pauli gates, etc. are different types of quantum logic gates. In one embodiment, grouping engine 201 groups the quantum logic gates selected by the user (e.g., developer, researcher) to build the quantum circuit (e.g., quantum circuit 109) based on the type of quantum logic gate (e.g., phase shift gate). In one embodiment, each quantum logic gate is associated with metadata, which includes the type of quantum logic gate. In one embodiment, such metadata is analyzed by grouping engine 201 to determine the type of the selected quantum logic gate.

In one embodiment, the type of quantum logic gate is determined by grouping engine 201 analyzing a data structure (e.g., table) that includes a listing of quantum logic gates along with their associated type of logic gate (e.g., rotation gate, phase shift gate). Upon identifying the quantum logic gate selected by the user to build the quantum circuit, grouping engine 201 determines the type of quantum logic gate selected by the user based on identifying the type of quantum logic gate that is associated with the selected quantum logic gate as specified in the data structure. In one embodiment, such a data structure is populated by an expert. In one embodiment, such a data structure is stored in a storage device (e.g., memory, disk unit) of classical computer 102.

In one embodiment, grouping engine 201 may group such quantum logic gates that were selected to build the quantum circuit (e.g., quantum circuit 109) based on the barrier. A “barrier,” as used herein, refers to the directive for circuit compilation to separate pieces of a circuit so that any optimizations or re-writes are constrained to only act between barriers. In one embodiment, such “barriers” are instructions provided to transpiler 112. Such instructions may then be obtained from transpiler 112 by grouping engine 201, which is used by grouping engine 201 to group such selected quantum logic gates based on the barrier.

In one embodiment, grouping engine 201 may group such quantum logic gates that were selected to build the quantum circuit (e.g., quantum circuit 109) based on customization. For example, such gates may be customized with features inherited from a base gate class as well as defined by one or more methods (e.g., decompose method, qid shape method, etc.). In one embodiment, grouping engine 201 may group custom gates into their own group from the other types of gates. In one embodiment, the inherited features and methods may be used by grouping engine 201 to group the quantum logic gates out of the custom quantum logic gates. In one embodiment, such inherited features and methods may be obtained by grouping engine 201 from the graphical quantum programming tool (e.g., IBM® Quantum Composer). In one embodiment, such inherited features and methods may be obtained by grouping engine 201 from the metadata associated with such custom quantum logic gates. In one embodiment, a data structure may include a listing of the base gate classes and associated defined methods. Such base gate classes and associated defined methods may be linked with a grouping number used by grouping engine 201 to group the custom gates into the appropriate group. For example, the custom gate that inherits the feature from the base gate class cirq.Gate and defined by the decompose and qid shape methods may be associated with group number 1. All custom gates with such properties will then be grouped together. In one embodiment, such a data structure is populated by an expert. In one embodiment, such a data structure is stored in a storage device (e.g., memory, disk unit) of classical computer 102.

In one embodiment, such grouped sets of quantum logic gates are associated with metadata, which indicates the particular gates contained within the gate grouping. In one embodiment, such metadata is stored in a data structure (e.g., table) by grouping engine 201. In one embodiment, such a data structure is stored in a storage device (e.g., memory, disk unit) of classical computer 102.

Classical computer 102 further includes a filter engine 202 configured to display filters on a graphical user interface (e.g., graphical user interface of the display of classical computer 102) in connection with the design of a quantum circuit being built by the user. In one embodiment, none of the filters are initially displayed unless the user (e.g., developer, researcher) chooses to reveal more information, such as the available filtering options, which may be displayed on the graphical user interface of classical computer 102. In one embodiment, the user may indicate to reveal more information, such as the available filtering options, by providing input to classical computer 102. In one embodiment, each of these filters is configured to display particular information regarding a grouped set of quantum logic gates that were grouped by grouping engine 201. A “filter,” as used herein, refers to a graphical display of information regarding a grouped set of quantum logic gates that may be displayed at or near the quantum circuit being built by the user (e.g., developer, researcher). For example, such filters may reside on the graphical user interface on the top of the quantum circuit (e.g., quantum circuit 109) being built by the user as shown in FIG. 3. In one embodiment, such filters display the following information: (1) illustrate which gates form the grouped set of quantum logic gates; (2) illustrate how the grouped set of quantum logic gates is transpiled to a hardware system; (3) provide information regarding the quantum logic gate(s) of the grouped set of quantum logic gates not being able to run on a quantum computer; (4) provide fidelity information regarding the grouped set of quantum logic gates; (5) illustrate interchangeable gates within the grouped set of quantum logic gates; and (6) illustrate performance of a quantum logic gate within the grouped set of quantum logic gates when it is transpiled to the quantum circuit. Such filters may display such information for the same or a different grouped set of quantum logic gates. A further description of these and other features is provided below.

Referring now to FIG. 3, FIG. 3 illustrates a graphical user interface 300 which displays a quantum circuit 109 being built by a user as well as filters 301A-301F (identified as “Filter A,” “Filter B,” “Filter C,” “Filter D, “Filter E” and “Filter F,” respectively, in FIG. 3) displayed in connection with quantum circuit 109 in accordance with an embodiment of the present disclosure. Filters 301A-301F may collectively or individually be referred to as filters 301 or filter 301, respectively.

As shown in FIG. 3, quantum circuit 109 includes a Hadamard gate 302 located on qubit wire q[0] 303. Additionally, as shown in FIG. 3, quantum circuit 109 includes a CNOT gate 304 to the right of Hadamard gate 302 on qubit wire q[0] 303, which acts on qubits q[0] 303 and q[1] 305. Furthermore, quantum circuit 109 includes wire c2 306, which is used for depicting information flowing to the classical register.

While FIG. 3 illustrates six filters 301, there may be any number of visually displayed filters 301 to assist the user (e.g., designer, researcher) in quantum circuit creation by providing relevant information regarding the grouped quantum logic gates so that the user has a better understanding regarding the capabilities and underlying mechanics of a given quantum circuit.

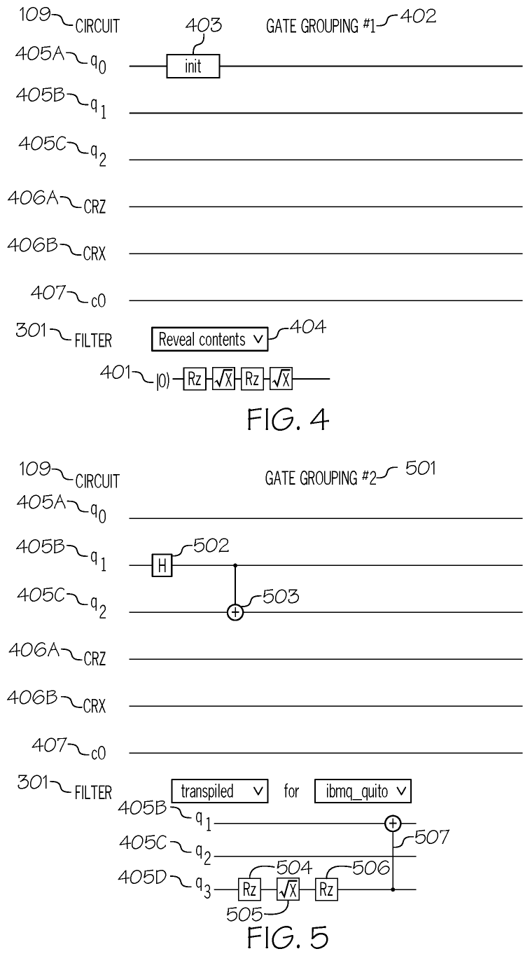

One such filter (referred to herein as the “reveal content filter”) is configured to illustrate which gates form the grouped set of quantum logic gates as shown in FIG. 4.

FIG. 4 illustrates a filter 301 which indicates which quantum logic gates (also referred to herein as simply “gates”) form the grouped set of quantum logic gates in accordance with an embodiment of the present disclosure.

Referring to FIG. 4, filter 301 (“reveal content filter”) reveals the quantum logic gates 401 forming the grouped set of quantum logic gates (“gate grouping #1” 402) of quantum circuit 109 identified by “init” 403 on one of the qubit wires, such as via the dropdown menu 404 (select “reveal contents”). Such quantum logic gates that form the grouped set of quantum logic gates may not initially be shown to save screen space. As a result, such logic gates that form the grouped set of quantum logic gates may be revealed by filter 301 (“reveal content filter”) only after the selection of the “reveal contents” via the dropdown menu 404 by the user via various input means of classical computer 102.

In one embodiment, filter engine 202 generates such information for the reveal content filter based on obtaining the metadata associated with the grouped set of quantum logic gates provided by grouping engine 201. As discussed above, such grouped sets of quantum logic gates are associated with metadata, which indicates the particular gates contained within the gate grouping. In one embodiment, such metadata is stored in a data structure (e.g., table) by grouping engine 201. In one embodiment, such a data structure is located in a storage device (e.g., memory, disk unit) of classical computer 102.

It is noted that in FIG. 4, qubit wires are identified by q₀, q₁ and q₂ 405A-405C, respectively. Furthermore, CRZ and CRX 406A-406B, respectively, are classical registers that receive the measurement operations (recorded as a classical bit on the classical register). Additionally, wire c0 407 is used for depicting information flowing to the classical register.

Another example of a filter 301 (“referred to herein as the “transpile content filter”) is a filter used to illustrate how the grouped set of quantum logic gates is transpiled to a hardware system, which is shown in FIG. 5.

Referring to FIG. 5, FIG. 5 illustrates a filter 301 (“transpile content filter”) which indicates how the grouped set of quantum logic gates is transpiled to a hardware system in accordance with an embodiment of the present disclosure.

As shown in FIG. 5, filter 301 (“transpile content filter”) allows the user (e.g., developer, researcher) to visually see how a particular grouping of quantum logic gates (“gate grouping #2” 501) would be transpiled to a hardware system using transpiler 112 (e.g., default transpiler of Qiskit®). For example, as shown in FIG. 5, the grouped set of quantum logic gates 501 includes a Hadamard gate 502 on qubit wire q₁ 405B and a CNOT gate 503 to the right of Hadamard gate 502 on qubit wire q₁ 405B, which acts on qubits q₁ 405B and q₂ 405C.

As further shown in FIG. 5, quantum logic gates 502 and 503 are transpiled to a hardware system using transpiler 112 by having quantum logic gates, Rz gate 504, Sqrt(X) gate 505 and Rz gate 506 on qubit wire q₃ 405D as well as having CNOT gate 507 on qubit wire q₃ 405D, which acts on qubits q₃ 405D and q₁ 405B.

In one embodiment, filter engine 202 generates such information for the transpile content filter based on instructing transpiler 112 to transpile the grouped set of quantum logic gates to a hardware system (e.g., quantum computer 101).

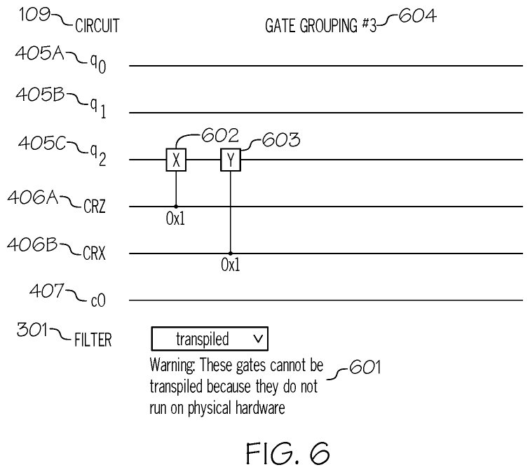

A further example of a filter 301 (referred to herein as the “content warning filter”) is a filter used to provide information regarding the quantum logic gate(s) of the grouped set of quantum logic gates not being able to run on a quantum computer, such as quantum computer 101, which is shown in FIG. 6.

Referring to FIG. 6, FIG. 6 illustrates a filter 301 (“content warning filter”) which provides information regarding the quantum logic gate(s) of the grouped set of quantum logic gates not being able to run on a quantum computer, such as quantum computer 101, in accordance with an embodiment of the present disclosure.

As shown in FIG. 6, filter 301 (“content warning filter”) generates the warning 601 (“These gates cannot be transpiled because they do not run on physical hardware”) regarding the quantum logic gates X 602 (Pauli-X gate) and Y 603 (Pauli-Y gate) of a grouped set of quantum logic gates (“gate grouping #3” 604).

In one embodiment, filter engine 202 generates such information for the content warning filter using a circuit transpile function (e.g., qiskit.compiler.transpile) which implements transpilation, which is the process of rewriting a given input circuit to match the topology of a specific quantum device and/or to optimize the circuit for execution on noisy quantum systems. During the transpilation, exceptions may arise, such as a transpiler error. Such error messages may be obtained by filter engine 202 to be used to provide the information for the content warning filter.

In another embodiment, filter engine 202 generates such information for the content warning filter based on a data structure containing a listing of warnings associated with a set of quantum logic gates on particular quantum wires and/or providing information to particular classical registers. For example, the data structure may include the set of quantum logic gates X 603 (Pauli-X gate) and Y 604 (Pauli-Y gate) providing measurement operations to classical registers CRZ and CRX, respectively. Such a topology may be associated with warnings, such as warning 601. As a result, after obtaining the topology of circuit 109, filter engine 202 determines if there are any warnings associated with such a topology in the data structure. Any identified warnings may then be used for the content warning filter. In one embodiment, such an embodiment may be populated by an expert. In one embodiment, such a data structure is located in a storage device (e.g., memory, disk unit) of classical computer 102.

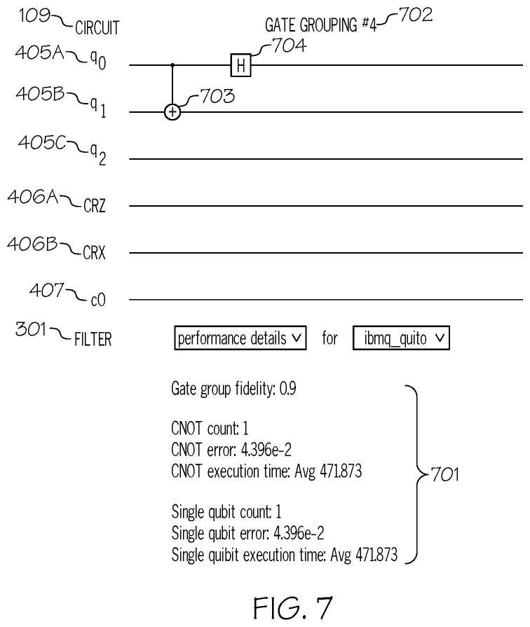

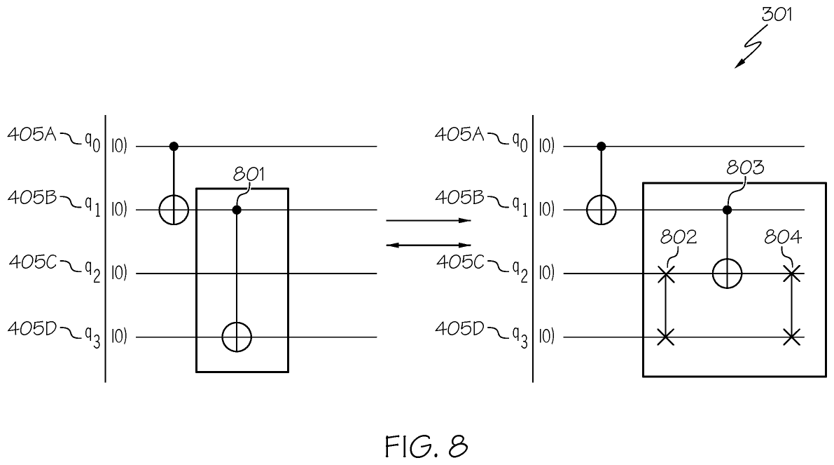

A further example of a filter 301 (referred to herein as the “performance details filter”) is a filter which provides fidelity information regarding the grouped set of quantum logic gates as shown in FIG. 7. “Fidelity,” as used herein, refers to the degree in which a model or simulation is accurate. For example, fidelity is a measure of how close the expected performance of the quantum logic gates of a grouped set of quantum logic gates is to the actual performance of the quantum logic gates.

In one embodiment, filter engine 202 analyzes a portion of quantum circuit 109 that includes the quantum logic gates of a grouped set of quantum logic gates to assess its fidelity, which may be used to identify performance bottlenecks.

In one embodiment, filter engine 202 assesses the fidelity regarding a grouped set of quantum logic gates using the state fidelity function (state_fidelity( )) of Qiskit®, which is configured to measure how close two quantum states are to each other, such as the quantum state of the expected performance and the quantum state of the actual performance. In one embodiment, such a result is a scaled value between 0 and 1, with 1 indicating a high fidelity.

For example, as shown in FIG. 7, FIG. 7 illustrates a filter 301 (“performance details filter”) which provides fidelity information regarding the grouped set of quantum logic gates in accordance with an embodiment of the present disclosure.

As shown in FIG. 7, filter 301 (“performance details filter”) provides performance statistics 701, such as the fidelity of a grouped set of quantum logic gates (“gate grouping #4” 702), such as the CNOT gate 703 on qubit wire q₀ 405A, which acts on qubits q₀ 405A and q₁ 405B, as well as Hadamard gate 704 on qubit wire q₀ 405A. Such performance statistics 701 may be used to assist the user in making decisions when building quantum circuits 109, such as identifying performance bottlenecks.

Another example of a filter 301 (referred to herein as the “interchangeable gate filter”) is a filter that illustrates interchangeable gates within the grouped set of quantum logic gates as shown in FIG. 8.

FIG. 8 illustrates a filter 301 (“interchangeable gate filter”) which indicates interchangeable gates within the grouped set of quantum logic gates in accordance with an embodiment of the present disclosure.

As shown in FIG. 8, CNOT gate 801 on qubit wire 405B, which acts on qubits q₁ 405B and q₃ 405D can be interchanged with SWAP gate 802 swapping the state of the two qubits q₂ 405C and q₃ 405D, a CNOT gate 803 on qubit wire q₁ 405B, which acts on qubits q₁ 405B and q₂ 405C, as well as SWAP gate 804 swapping the state of the two qubits q₂ 405C and q₃ 405D.

In one embodiment, filter engine 202 obtains such information for the interchangeable gate filter based on a data structure containing a listing of various topologies associated with interchangeable topologies. For example, the topology of a CNOT gate on qubit q₀ may be associated with the interchangeable topology of a SWAP gate swapping the state of qubits q₂ and q₃, a CNOT gate on qubit q₁, which acts on qubits q₁ 405B and q₂ 405C, and a SWAP gate swapping the state of qubits q₂ and q₃. Upon identifying the topology of the quantum logic gates (or a portion thereof) of the grouped set of quantum logic gates by filter engine 202, filter engine 202 analyzes the data structure discussed above for a matching topology. Upon identifying a matching topology, filter engine 202 determines if there are any interchangeable topologies for the matching topology in the data structure. Such interchangeable topologies may be used to provide information pertaining to the interchangeable gates within the grouped set of quantum logic gates for the interchangeable gate filter. In one embodiment, the data structure discussed above may be populated by an expert. In one embodiment, such a data structure is located in a storage device (e.g., memory, disk unit) of classical computer 102.

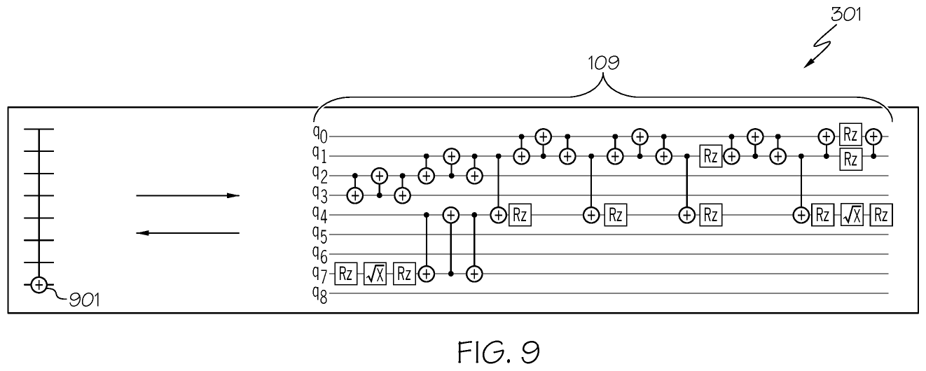

A further example of a filter 301 (“transpiler performance filter”) is a filter which illustrates the performance of a quantum logic gate within the grouped set of quantum logic gates when it is transpiled to the quantum circuit as shown in FIG. 9.

FIG. 9 illustrates a filter 301 (“transpiler performance filter”) which indicates the performance of a quantum logic gate within the grouped set of quantum logic gates when it is transpiled to quantum circuit 109 in accordance with an embodiment of the present disclosure.

As shown in FIG. 9, gate 901 within a grouped set of quantum logic gates is transpiled to circuit 109, which allows the user (e.g., developer, researcher) to visually understand the performance of quantum circuit 109 being built by the user thereby assisting them to make better decisions.

In one embodiment, filter engine 202 obtains such information for the transpiler performance filter by instructing transpiler 112 (e.g., default transpiler of Qiskit®) to transpile a quantum logic gate within the grouped set of quantum logic gates to quantum circuit 109 being built by the user.

A further description of these and other functions is provided below in connection with the discussion of the method for assisting users in creating quantum circuits by visually displaying filters, which are used to provide relevant information regarding grouped quantum logic gates.

Prior to the discussion of the method for assisting users in creating quantum circuits by visually displaying filters, which are used to provide relevant information regarding grouped quantum logic gates, a description of the hardware configuration of classical computer 102 (FIG. 1) is provided below in connection with FIG. 10.

Referring now to FIG. 10, in conjunction with FIG. 1, FIG. 10 illustrates an embodiment of the present disclosure of the hardware configuration of classical computer 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code 1001 involved in performing the inventive methods, such as assisting users in creating quantum circuits by visually displaying filters, which are used to provide relevant information regarding grouped quantum logic gates. In addition to block 1001, computing environment 1000 includes, for example, classical computer 102, network 113, such as a wide area network (WAN), end user device (EUD) 1002, remote server 1003, public cloud 1004, and private cloud 1005. In this embodiment, classical computer 102 includes processor set 1006 (including processing circuitry 1007 and cache 1008), communication fabric 1009, volatile memory 1010, persistent storage 1011 (including operating system 1012 and block 1001, as identified above), peripheral device set 1013 (including user interface (UI) device set 1014, storage 1015, and Internet of Things (IoT) sensor set 1016), and network module 1017. Remote server 1003 includes remote database 1018. Public cloud 1004 includes gateway 1019, cloud orchestration module 1020, host physical machine set 1021, virtual machine set 1022, and container set 1023.

Classical computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1018. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically classical computer 102, to keep the presentation as simple as possible. Classical computer 102 may be located in a cloud, even though it is not shown in a cloud in FIG. 10. On the other hand, classical computer 102 is not required to be in a cloud except to any extent as may be affirmatively indicated.

Processor set 1006 includes one, or more, computer processors of any type now known or to be developed in the future. Processing circuitry 1007 may be distributed over multiple packages, for example, multiple, coordinated integrated circuit chips. Processing circuitry 1007 may implement multiple processor threads and/or multiple processor cores. Cache 1008 is memory that is located in the processor chip package(s) and is typically used for data or code that should be available for rapid access by the threads or cores running on processor set 1006. Cache memories are typically organized into multiple levels depending upon relative proximity to the processing circuitry. Alternatively, some, or all, of the cache for the processor set may be located “off chip.” In some computing environments, processor set 1006 may be designed for working with qubits and performing quantum computing.

Computer readable program instructions are typically loaded onto classical computer 102 to cause a series of operational steps to be performed by processor set 1006 of classical computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1008 and the other storage media discussed below. The program instructions, and associated data, are accessed by processor set 1006 to control and direct performance of the inventive methods. In computing environment 1000, at least some of the instructions for performing the inventive methods may be stored in block 1001 in persistent storage 1011.

Communication fabric 1009 is the signal conduction paths that allow the various components of classical computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 1010 is any type of volatile memory now known or to be developed in the future. Examples include dynamic type random access memory (RAM) or static type RAM. Typically, the volatile memory is characterized by random access, but this is not required unless affirmatively indicated. In classical computer 102, the volatile memory 1010 is located in a single package and is internal to classical computer 102, but, alternatively or additionally, the volatile memory may be distributed over multiple packages and/or located externally with respect to classical computer 102.

Persistent Storage 1011 is any form of non-volatile storage for computers that is now known or to be developed in the future. The non-volatility of this storage means that the stored data is maintained regardless of whether power is being supplied to classical computer 102 and/or directly to persistent storage 1011. Persistent storage 1011 may be a read only memory (ROM), but typically at least a portion of the persistent storage allows writing of data, deletion of data and re-writing of data. Some familiar forms of persistent storage include magnetic disks and solid state storage devices. Operating system 1012 may take several forms, such as various known proprietary operating systems or open source Portable Operating System Interface type operating systems that employ a kernel. The code included in block 1001 typically includes at least some of the computer code involved in performing the inventive methods.

Peripheral device set 1013 includes the set of peripheral devices of classical computer 102. Data communication connections between the peripheral devices and the other components of classical computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1014 may include components such as a display screen, speaker, microphone, wearable devices (such as goggles and smart watches), keyboard, mouse, printer, touchpad, game controllers, and haptic devices. Storage 1015 is external storage, such as an external hard drive, or insertable storage, such as an SD card. Storage 1015 may be persistent and/or volatile. In some embodiments, storage 1015 may take the form of a quantum computing storage device for storing data in the form of qubits. In embodiments where classical computer 102 is required to have a large amount of storage (for example, where classical computer 102 locally stores and manages a large database) then this storage may be provided by peripheral storage devices designed for storing very large amounts of data, such as a storage area network (SAN) that is shared by multiple, geographically distributed computers. IoT sensor set 1016 is made up of sensors that can be used in Internet of Things applications. For example, one sensor may be a thermometer and another sensor may be a motion detector.

Network module 1017 is the collection of computer software, hardware, and firmware that allows classical computer 102 to communicate with other computers through WAN 113. Network module 1017 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1017 are performed on the same physical hardware device. In other embodiments (for example, embodiments that utilize software-defined networking (SDN)), the control functions and the forwarding functions of network module 1017 are performed on physically separate devices, such that the control functions manage several different network hardware devices. Computer readable program instructions for performing the inventive methods can typically be downloaded to classical computer 102 from an external computer or external storage device through a network adapter card or network interface included in network module 1017.

WAN 113 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 1002 is any computer system that is used and controlled by an end user (for example, a customer of an enterprise that operates classical computer 102), and may take any of the forms discussed above in connection with classical computer 102. EUD 1002 typically receives helpful and useful data from the operations of classical computer 102. For example, in a hypothetical case where classical computer 102 is designed to provide a recommendation to an end user, this recommendation would typically be communicated from network module 1017 of classical computer 102 through WAN 113 to EUD 1002. In this way, EUD 1002 can display, or otherwise present, the recommendation to an end user. In some embodiments, EUD 1002 may be a client device, such as thin client, heavy client, mainframe computer, desktop computer and so on.

Remote server 1003 is any computer system that serves at least some data and/or functionality to classical computer 102. Remote server 1003 may be controlled and used by the same entity that operates classical computer 102. Remote server 1003 represents the machine(s) that collect and store helpful and useful data for use by other computers, such as classical computer 102. For example, in a hypothetical case where classical computer 102 is designed and programmed to provide a recommendation based on historical data, then this historical data may be provided to classical computer 102 from remote database 1018 of remote server 1003.

Public cloud 1004 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1004 is performed by the computer hardware and/or software of cloud orchestration module 1020. The computing resources provided by public cloud 1004 are typically implemented by virtual computing environments that run on various computers making up the computers of host physical machine set 1021, which is the universe of physical computers in and/or available to public cloud 1004. The virtual computing environments (VCEs) typically take the form of virtual machines from virtual machine set 1022 and/or containers from container set 1023. It is understood that these VCEs may be stored as images and may be transferred among and between the various physical machine hosts, either as images or after instantiation of the VCE. Cloud orchestration module 1020 manages the transfer and storage of images, deploys new instantiations of VCEs and manages active instantiations of VCE deployments. Gateway 1019 is the collection of computer software, hardware, and firmware that allows public cloud 1004 to communicate through WAN 113.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 1005 is similar to public cloud 1004, except that the computing resources are only available for use by a single enterprise. While private cloud 1005 is depicted as being in communication with WAN 113 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1004 and private cloud 1005 are both part of a larger hybrid cloud.

Block 1001 further includes the software components discussed above in connection with FIGS. 2-9 to assist users in creating quantum circuits by visually displaying filters, which are used to provide relevant information regarding grouped quantum logic gates. In one embodiment, such components may be implemented in hardware. The functions discussed above performed by such components are not generic computer functions. As a result, classical computer 102 is a particular machine that is the result of implementing specific, non-generic computer functions.

In one embodiment, the functionality of such software components of classical computer 102, including the functionality for assisting users in creating quantum circuits by visually displaying filters, which are used to provide relevant information regarding grouped quantum logic gates, may be embodied in an application specific integrated circuit.

As stated above, graphical quantum programming tools are software tools used for building and simulating quantum circuits for use in quantum computers, which perform quantum computations. A quantum circuit is a model for quantum computation, similar to classical circuits, in which a computation is a sequence of quantum logic gates, measurements, initializations of qubits to known values, and possibly other actions. The minimum set of actions that a quantum circuit needs to be able to perform on the qubits to enable quantum computation is known as DiVincenzo's criteria. In quantum computing, a qubit or quantum bit is a basic unit of quantum information—the quantum version of the classic binary bit physically realized with a two-state device. A qubit is a two-state (or two-level) quantum-mechanical system, one of the simplest quantum systems displaying the peculiarity of quantum mechanics. Examples include the spin of the electron in which the two levels can be taken as spin up and spin down; or the polarization of a single photon in which the two states can be taken to be the vertical polarization and the horizontal polarization. In a classical system, a bit would have to be in one state or the other. However, quantum mechanics allow the qubit to be in a coherent superposition of both states simultaneously, a property that is fundamental to quantum mechanics and quantum computing. Quantum circuits are written such that the horizontal axis is time, starting at the left hand side and ending at the right hand side. Horizontal lines are qubits and doubled lines represent classical bits. The items that are connected by these lines are operations performed on the qubits, such as measurements or gates. These lines define the sequence of events and are usually not physical cables. As discussed above, graphical quantum programming tools (e.g., IBM® Quantum Composer, Quirk) are software tools used for building and simulating such quantum circuits. Typically, such tools allow the user (e.g., developer, researcher) to build the quantum circuit via drag and drop operations, which are then run on quantum hardware or simulators. For example, a quantum circuit may be built by dragging and dropping quantum logic gates. However, such graphical quantum programming tools fail to provide a deeper understanding and robust circuit development experience. For example, such tools fail to provide relevant information associated with particular circuit elements to assist the user in making better decisions as well as speeding up the design process in building the quantum circuit.

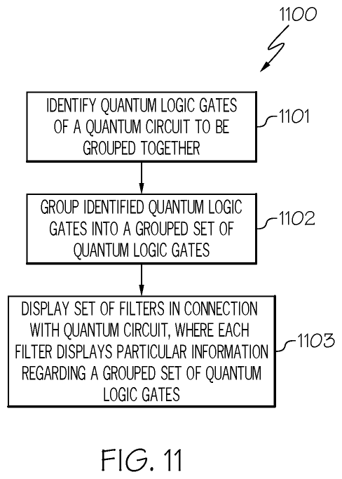

The embodiments of the present disclosure expand the capabilities in quantum circuit creation by grouping quantum logic gates and visually displaying “filters” providing relevant information regarding the grouped quantum logic gates so that the users (e.g., developers, researchers) can better understand the capabilities and underlying mechanics of a given quantum circuit as discussed below in connection with FIG. 11.

FIG. 11 is a flowchart of a method 1100 for assisting users in creating quantum circuits, such as quantum circuit 109, by visually displaying filters, which are used to provide relevant information regarding grouped quantum logic gates, in accordance with an embodiment of the present disclosure.

Referring to FIG. 11, in conjunction with FIGS. 1-10, in step 1101, grouping engine 201 of classical computer 102 identifies quantum logic gates of a quantum circuit, such as quantum circuit 109. being designed by a user, to be grouped together.

In step 1102, grouping engine 201 of classical computer 102 groups the identified quantum logic gates into a grouped set of quantum logic gates.

As discussed above, in one embodiment, the user (e.g., designer, researcher) builds a quantum circuit 109 by selecting quantum logic gates, such as a Hadamard gate or a CNOT gate, using a graphical quantum programming tool (e.g., IBM® Quantum Composer). Such quantum logic gates manipulate qubits and are the building blocks of quantum circuits 109. In one embodiment, such quantum logic gates are used to construct quantum circuit 109 via a drag and drop operation, such as by selecting a quantum logic gate (e.g., Hadamard gate) and then dragging the selected quantum logic gate onto the qubit wire. In one embodiment, grouping engine 201 is configured to group such quantum logic gates based on one or more of the following characteristics: color, type, barrier, customization, etc. Using these characteristics, grouping engine 201 identifies those quantum logic gates that should be grouped together.

For example, such quantum logic gates may be color-coded by the graphical quantum programming tool based on their functionality. For instance, CNOT and SWAP quantum logic gates may be color-coded the same color since a SWAP quantum logic gate can be obtained from three CNOT gates. In another example, the RX, RY, RXX and RZZ quantum logic gates may be color-coded the same color since such gates are rotation gates. In one embodiment, grouping engine 201 groups such quantum logic gates selected by the user to build a quantum circuit (e.g., quantum circuit 109) based on the color assigned to such gates as indicated by the graphical quantum programming tool. For example, those selected quantum logic gates that are assigned the same color may be grouped together by grouping engine 201 to form a grouped set of quantum logic gates.

In another example, grouping engine 201 may group such quantum logic gates that were selected to build the quantum circuit (e.g., quantum circuit 109) based on type. For example, rotation gates, phase shift gates, controlled gates, Pauli gates, etc. are different types of quantum logic gates. In one embodiment, grouping engine 201 groups the quantum logic gates selected by the user (e.g., developer, researcher) to build the quantum circuit (e.g., quantum circuit 109) based on the type of quantum logic gate (e.g., phase shift gate). In one embodiment, each quantum logic gate is associated with metadata, which includes the type of quantum logic gate. In one embodiment, such metadata is analyzed by grouping engine 201 to determine the type of the selected quantum logic gate.

In one embodiment, the type of quantum logic gate is determined by grouping engine 201 analyzing a data structure (e.g., table) that includes a listing of quantum logic gates along with their associated type of logic gate (e.g., rotation gate, phase shift gate). Upon identifying the quantum logic gate selected by the user to build the quantum circuit, grouping engine 201 determines the type of quantum logic gate selected by the user based on identifying the type of quantum logic gate that is associated with the selected quantum logic gate as specified in the data structure. In one embodiment, such a data structure is populated by an expert. In one embodiment, such a data structure is stored in a storage device (e.g., storage device 1011, 1015) of classical computer 102.

In one embodiment, grouping engine 201 may group such quantum logic gates that were selected to build the quantum circuit (e.g., quantum circuit 109) based on the barrier. A “barrier,” as used herein, refers to the directive for circuit compilation to separate pieces of a circuit so that any optimizations or re-writes are constrained to only act between barriers. In one embodiment, such “barriers” are instructions provided to transpiler 112. Such instructions may then be obtained from transpiler 112 by grouping engine 201, which is used by grouping engine 201 to group such selected quantum logic gates based on the barrier.

In one embodiment, grouping engine 201 may group such quantum logic gates that were selected to build the quantum circuit (e.g., quantum circuit 109) based on customization. For example, such gates may be customized with features inherited from a base gate class as well as defined by one or more methods (e.g., decompose method, qid shape method, etc.). In one embodiment, grouping engine 201 may group custom gates into their own group from the other types of gates. In one embodiment, the inherited features and methods may be used by grouping engine 201 to group the quantum logic gates out of the custom quantum logic gates. In one embodiment, such inherited features and methods may be obtained by grouping engine 201 from the graphical quantum programming tool (e.g., IBM® Quantum Composer). In one embodiment, such inherited features and methods may be obtained by grouping engine 201 from the metadata associated with such custom quantum logic gates. In one embodiment, a data structure may include a listing of the base gate classes and associated defined methods. Such base gate classes and associated defined methods may be linked with a grouping number used by grouping engine 201 to group the custom gates into the appropriate group. For example, the custom gate that inherits the feature from the base gate class cirq.Gate and defined by the decompose and qid shape methods may be associated with group number 1. All custom gates with such properties will then be grouped together. In one embodiment, such a data structure is populated by an expert. In one embodiment, such a data structure is stored in a storage device (e.g., storage device 1011, 1015) of classical computer 102.

In one embodiment, such grouped sets of quantum logic gates are associated with metadata, which indicates the particular gates contained within the gate grouping. In one embodiment, such metadata is stored in a data structure (e.g., table) by grouping engine 201. In one embodiment, such a data structure is stored in a storage device (e.g., storage device 1011, 1015) of classical computer 102.

In step 1103, filter engine 202 of classical computer 102 displays a set of filters 301 in connection with the quantum circuit (e.g., quantum circuit 109) being designed by the user, where each filter 301 displays particular information regarding a grouped set of quantum logic gates.

As stated above, filter engine 202 displays filters 301 on a graphical user interface (e.g., graphical user interface of the display of classical computer 102) in connection with the design of a quantum circuit being built by the user. In one embodiment, none of the filters are initially displayed unless the user (e.g., developer, researcher) chooses to reveal more information, such as the available filtering options, which may be displayed on the graphical user interface of classical computer 102. In one embodiment, the user may indicate to reveal more information, such as the available filtering options, by providing input to classical computer 102. In one embodiment, each of these filters 301 is configured to display particular information regarding a grouped set of quantum logic gates that were grouped by grouping engine 201. A “filter” 301, as used herein, refers to a graphical display of information regarding a grouped set of quantum logic gates that may be displayed at or near quantum circuit 109 being built by the user (e.g., developer, researcher). For example, such filters 301 may reside on the graphical user interface on the top of the quantum circuit (e.g., quantum circuit 109) being built by the user as shown in FIG. 3. In one embodiment, such filters display the following information: (1) illustrate which gates form the grouped set of quantum logic gates; (2) illustrate how the grouped set of quantum logic gates is transpiled to a hardware system; (3) provide information regarding the quantum logic gate(s) of the grouped set of quantum logic gates not being able to run on a quantum computer; (4) provide fidelity information regarding the grouped set of quantum logic gates; (5) illustrate interchangeable gates within the grouped set of quantum logic gates; and (6) illustrate performance of a quantum logic gate within the grouped set of quantum logic gates when it is transpiled to the quantum circuit. Such filters 301 may display such information for the same or a different grouped set of quantum logic gates. An illustration of filters 301 being displayed in connection with quantum circuit 109 being built by a user is provided by FIG. 3.

For example, as shown in FIG. 3, FIG. 3 illustrates a graphical user interface 300 which displays a quantum circuit 109 being built by a user as well as filters 301A-301F (identified as “Filter A,” “Filter B,” “Filter C,” “Filter D, “Filter E” and “Filter F,” respectively, in FIG. 3) displayed in connection with quantum circuit 109.

While FIG. 3 illustrates six filters 301, there may be any number of visually displayed filters 301 to assist the user (e.g., designer, researcher) in quantum circuit creation by providing relevant information regarding the grouped quantum logic gates so that the user has a better understanding regarding the capabilities and underlying mechanics of a given quantum circuit.

One such filter 301 (referred to herein as the “reveal content filter”) is configured to illustrate which gates form the grouped set of quantum logic gates as shown in FIG. 4.

In one embodiment, filter engine 202 generates such information for the reveal content filter based on obtaining the metadata associated with the grouped set of quantum logic gates provided by grouping engine 201. As discussed above, such grouped sets of quantum logic gates are associated with metadata, which indicates the particular gates contained within the gate grouping. In one embodiment, such metadata is stored in a data structure (e.g., table) by grouping engine 201. In one embodiment, such a data structure is located in a storage device (e.g., storage device 1011, 1015) of classical computer 102.

Another example of a filter 301 (“referred to herein as the “transpile content filter”) is a filter used to illustrate how the grouped set of quantum logic gates is transpiled to a hardware system, which is shown in FIG. 5.

In one embodiment, filter engine 202 generates such information for the transpile content filter based on instructing transpiler 112 to transpile the grouped set of quantum logic gates to a hardware system (e.g., quantum computer 101).

A further example of a filter 301 (referred to herein as the “content warning filter”) is a filter used to provide information regarding the quantum logic gate(s) of the grouped set of quantum logic gates not being able to run on a quantum computer, such as quantum computer 101, which is shown in FIG. 6.

In one embodiment, filter engine 202 generates such information for the content warning filter using a circuit transpile function (e.g., qiskit.compiler.transpile) which implements transpilation, which is the process of rewriting a given input circuit to match the topology of a specific quantum device and/or to optimize the circuit for execution on noisy quantum systems. During the transpilation, exceptions may arise, such as a transpiler error. Such error messages may be obtained by filter engine 202 to be used to provide the information for the content warning filter 301.

In another embodiment, filter engine 202 generates such information for the content warning filter based on a data structure containing a listing of warnings associated with a set of quantum logic gates on particular quantum wires and/or providing information to particular classical registers. For example, the data structure may include the set of quantum logic gates X 603 (Pauli-X gate) and Y 604 (Pauli-Y gate) providing measurement operations to classical registers CRZ and CRX, respectively. Such a topology may be associated with warnings, such as warning 601. As a result, after obtaining the topology of circuit 109, filter engine 202 determines if there are any warnings associated with such a topology in the data structure. Any identified warnings may then be used for the content warning filter 301. In one embodiment, such an embodiment may be populated by an expert. In one embodiment, such a data structure is located in a storage device (e.g., storage device 1101, 1105) of classical computer 102.

A further example of a filter 301 (referred to herein as the “performance details filter”) is a filter which provides fidelity information regarding the grouped set of quantum logic gates as shown in FIG. 7. “Fidelity,” as used herein, refers to the degree in which a model or simulation is accurate. For example, fidelity is a measure of how close the expected performance of the quantum logic gates of a grouped set of quantum logic gates is to the actual performance of the quantum logic gates.

In one embodiment, filter engine 202 analyzes a portion of quantum circuit 109 that includes the quantum logic gates of a grouped set of quantum logic gates to assess its fidelity, which may be used to identify performance bottlenecks.

In one embodiment, filter engine 202 assesses the fidelity regarding a grouped set of quantum logic gates using the state fidelity function (state_fidelity( )) of Qiskit®, which is configured to measure how close two quantum states are to each other, such as the quantum state of the expected performance and the quantum state of the actual performance. In one embodiment, such a result is a scaled value between 0 and 1, with 1 indicating a high fidelity.

Another example of a filter 301 (referred to herein as the “interchangeable gate filter”) is a filter that illustrates interchangeable gates within the grouped set of quantum logic gates as shown in FIG. 8.

In one embodiment, filter engine 202 obtains such information for the interchangeable gate filter based on a data structure containing a listing of various topologies associated with interchangeable topologies. For example, the topology of a CNOT gate on qubit q₀ may be associated with the interchangeable topology of a SWAP gate swapping the state of qubits q₂ and q₃, a CNOT gate on qubit q₁ and a SWAP gate swapping the state of qubits q₂ and q₃. Upon identifying the topology of the quantum logic gates (or a portion thereof) of the grouped set of quantum logic gates by filter engine 202, filter engine 202 analyzes the data structure discussed above for a matching topology. Upon identifying a matching topology, filter engine 202 determines if there are any interchangeable topologies for the matching topology in the data structure. Such interchangeable topologies may be used to provide information pertaining to the interchangeable gates within the grouped set of quantum logic gates for the interchangeable gate filter. In one embodiment, the data structure discussed above may be populated by an expert. In one embodiment, such a data structure is located in a storage device (e.g., storage device 1101, 1105) of classical computer 102.

A further example of a filter 301 (“transpiler performance filter”) is a filter which illustrates the performance of a quantum logic gate within the grouped set of quantum logic gates when it is transpiled to the quantum circuit as shown in FIG. 9.

In one embodiment, filter engine 202 obtains such information for the transpiler performance filter by instructing transpiler 112 (e.g., default transpiler of Qiskit®) to transpile a quantum logic gate within the grouped set of quantum logic gates to quantum circuit 109 being built by the user.

As a result of the foregoing, the principles of the present disclosure provide a means for assisting the user in creating quantum circuits by visually displaying “filters” in connection with a quantum circuit being designed by a user (e.g., developer, researcher), where such filters provide relevant information regarding a grouped set of quantum logic gates so that the user can better understand the capabilities and underlying mechanics of the quantum circuit.

Furthermore, the principles of the present disclosure improve the technology or technical field involving graphical quantum programming tools.

As discussed above, graphical quantum programming tools are software tools used for building and simulating quantum circuits for use in quantum computers, which perform quantum computations. A quantum circuit is a model for quantum computation, similar to classical circuits, in which a computation is a sequence of quantum logic gates, measurements, initializations of qubits to known values, and possibly other actions. The minimum set of actions that a quantum circuit needs to be able to perform on the qubits to enable quantum computation is known as DiVincenzo's criteria. In quantum computing, a qubit or quantum bit is a basic unit of quantum information—the quantum version of the classic binary bit physically realized with a two-state device. A qubit is a two-state (or two-level) quantum-mechanical system, one of the simplest quantum systems displaying the peculiarity of quantum mechanics. Examples include the spin of the electron in which the two levels can be taken as spin up and spin down; or the polarization of a single photon in which the two states can be taken to be the vertical polarization and the horizontal polarization. In a classical system, a bit would have to be in one state or the other. However, quantum mechanics allow the qubit to be in a coherent superposition of both states simultaneously, a property that is fundamental to quantum mechanics and quantum computing. Quantum circuits are written such that the horizontal axis is time, starting at the left hand side and ending at the right hand side. Horizontal lines are qubits and doubled lines represent classical bits. The items that are connected by these lines are operations performed on the qubits, such as measurements or gates. These lines define the sequence of events and are usually not physical cables. As discussed above, graphical quantum programming tools (e.g., IBM® Quantum Composer, Quirk) are software tools used for building and simulating such quantum circuits. Typically, such tools allow the user (e.g., developer, researcher) to build the quantum circuit via drag and drop operations, which are then run on quantum hardware or simulators. For example, a quantum circuit may be built by dragging and dropping quantum logic gates. However, such graphical quantum programming tools fail to provide a deeper understanding and robust circuit development experience. For example, such tools fail to provide relevant information associated with particular circuit elements to assist the user in making better decisions as well as speeding up the design process in building the quantum circuit.

Embodiments of the present disclosure improve such technology by identifying quantum logic gates of a quantum circuit (being designed by a user) that are to be grouped together. Upon identifying such quantum logic gates, those quantum logic gates are grouped together into a grouped set of quantum logic gates. In one embodiment, such quantum logic gates are identified to be grouped together based on one or more of the following characteristics: color, type, barrier, customization, etc. Upon forming a grouped set of quantum logic gates, filters are displayed in connection with the quantum circuit being designed by the user, where each of these filters is configured to display particular information regarding the grouped set of quantum logic gates. A “filter,” as used herein, refers to a graphical display of information regarding the grouped quantum logic gates that may be displayed at or near the quantum circuit being built by the user (e.g., developer, researcher). For example, such filters may be visually displayed on the top of the quantum circuit being built by the user in a graphical user interface. In one embodiment, such filters display the following information: (1) illustrate which gates form the grouped set of quantum logic gates; (2) illustrate how the grouped set of quantum logic gates is transpiled to a hardware system; (3) provide information regarding the quantum logic gate(s) of the grouped set of quantum logic gates not being able to run on a quantum computer; (4) provide fidelity information regarding the grouped set of quantum logic gates; (5) illustrate interchangeable gates within the grouped set of quantum logic gates; and (6) illustrate performance of a quantum logic gate within the grouped set of quantum logic gates when it is transpiled to the quantum circuit. In this manner, users are provided a deeper understanding and a robust circuit development experience by providing relevant information regarding a grouped set of quantum logic gates so that the user can better understand the capabilities and underlying mechanics of the quantum circuit. Furthermore, in this manner, there is an improvement in the technical field involving graphical quantum programming tools.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for assisting users in creating quantum circuits, the method comprising:
identifying quantum logic gates of a quantum circuit to be grouped together;
grouping said identified quantum logic gates into a grouped set of quantum logic gates; and
displaying a plurality of filters in connection with said quantum circuit, wherein each of said plurality of filters is configured to display particular information regarding said grouped set of quantum logic gates.

2. The method as recited in claim 1, wherein one of said plurality of filters is configured to illustrate which gates form said grouped set of quantum logic gates.

3. The method as recited in claim 1, wherein one of said plurality of filters is configured to illustrate how said grouped set of quantum logic gates is transpiled to a hardware system.

4. The method as recited in claim 1, wherein one of said plurality of filters is configured to provide information regarding one or more quantum logic gates of said grouped set of quantum logic gates not being able to run on a quantum computer.

5. The method as recited in claim 1, wherein one of said plurality of filters is configured to provide fidelity information regarding said grouped set of quantum logic gates.

6. The method as recited in claim 1, wherein one of said plurality of filters is configured to illustrate interchangeable gates within said grouped set of quantum logic gates, wherein one of said plurality of filters is configured to illustrate performance of a quantum logic gate within said grouped set of quantum logic gates when it is transpiled to said quantum circuit.

7. The method as recited in claim 1, wherein said quantum logic gates of said quantum circuit are identified to be grouped together based on one or more of the following: color, type, barrier, and customization.

8. A computer program product for assisting users in creating quantum circuits, the computer program product comprising one or more computer readable storage mediums having program code embodied therewith, the program code comprising programming instructions for:
identifying quantum logic gates of a quantum circuit to be grouped together;
grouping said identified quantum logic gates into a grouped set of quantum logic gates; and
displaying a plurality of filters in connection with said quantum circuit, wherein each of said plurality of filters is configured to display particular information regarding said grouped set of quantum logic gates.

9. The computer program product as recited in claim 8, wherein one of said plurality of filters is configured to illustrate which gates form said grouped set of quantum logic gates.

10. The computer program product as recited in claim 8, wherein one of said plurality of filters is configured to illustrate how said grouped set of quantum logic gates is transpiled to a hardware system.

11. The computer program product as recited in claim 8, wherein one of said plurality of filters is configured to provide information regarding one or more quantum logic gates of said grouped set of quantum logic gates not being able to run on a quantum computer.

12. The computer program product as recited in claim 8, wherein one of said plurality of filters is configured to provide fidelity information regarding said grouped set of quantum logic gates.

13. The computer program product as recited in claim 8, wherein one of said plurality of filters is configured to illustrate interchangeable gates within said grouped set of quantum logic gates, wherein one of said plurality of filters is configured to illustrate performance of a quantum logic gate within said grouped set of quantum logic gates when it is transpiled to said quantum circuit.

14. The computer program product as recited in claim 8, wherein said quantum logic gates of said quantum circuit are identified to be grouped together based on one or more of the following: color, type, barrier, and customization.

15. A system, comprising:
a memory for storing a computer program for assisting users in creating quantum circuits; and
a processor connected to said memory, wherein said processor is configured to execute program instructions of the computer program comprising:
identifying quantum logic gates of a quantum circuit to be grouped together;
grouping said identified quantum logic gates into a grouped set of quantum logic gates; and
displaying a plurality of filters in connection with said quantum circuit, wherein each of said plurality of filters is configured to display particular information regarding said grouped set of quantum logic gates.

16. The system as recited in claim 15, wherein one of said plurality of filters is configured to illustrate which gates form said grouped set of quantum logic gates.

17. The system as recited in claim 15, wherein one of said plurality of filters is configured to illustrate how said grouped set of quantum logic gates is transpiled to a hardware system.

18. The system as recited in claim 15, wherein one of said plurality of filters is configured to provide information regarding one or more quantum logic gates of said grouped set of quantum logic gates not being able to run on a quantum computer.

19. The system as recited in claim 15, wherein one of said plurality of filters is configured to provide fidelity information regarding said grouped set of quantum logic gates.

20. The system as recited in claim 15, wherein one of said plurality of filters is configured to illustrate interchangeable gates within said grouped set of quantum logic gates, wherein one of said plurality of filters is configured to illustrate performance of a quantum logic gate within said grouped set of quantum logic gates when it is transpiled to said quantum circuit.
